(19) United States
(12) Patent Application Publication
(10) Pub. No.: US 2024/0246256 A1
(43) Pub. Date: Jul. 25, 2024

(54) COMBINED PROCESS OF HYDROLYSIS AND ESTERIFICATION OF WOOD

(71) Applicant: Peter Klaas, Martofte (DK)

(72) Inventor: Peter Klaas, Martofte (DK)

(21) Appl. No.: 18/283,845

(22) PCT Filed: Mar. 25, 2022
(86) PCT No.: PCT/DK2022/050060

§ 371 Date: Sep. 25, 2023

(30) Foreign Application Priority Data
Mar. 25, 2021 (DK) PA 2021 70141

(51) Int. Cl. B27K 3/15; B27K 3/02; B27K 5/00

(52) U.S. Cl. CPC B27K 3/156; B27K 3/0292; B27K 5/001; B27K 5/0075; B27K 2240/20

(57) ABSTRACT

A method of treating a cellulose-based material, for example wood and engineered wood is provided, wherein the process involves the following steps: selecting and placing the cellulose-based material in a treatment chamber; impregnating the cellulose-based material with an impregnating agent consisting of an aqueous solution comprising a fluid suitable for esterification; facilitating a hydrolysis process whereby the impregnating agent reacts resulting in the formation of esters and polyesters inside the cellulosed-based material.

### CROSS-REFERENCE TO RELATED APPLICATIONS

This application claims priority to PCT Application No. PCT/EP2022/050060, having a filing date of Mar. 25, 2022, which is based DK Application No. PA 2021 70141, having a filing date of Mar. 25, 2021, the entire contents both of which are hereby incorporated by reference.

### FIELD OF TECHNOLOGY

The following is directed to a novel and inventive method of improving and preserving cellulose-based materials, in particular wood, such that the wood exhibits improved durability characteristics after the treatment. The treated wood may be used in aggressive environments, and be treated at substantially lower cost for non-biocidal modification than what is known in the conventional art.

### BACKGROUND

Various modification methods have been developed in order to improve the durability characteristics of wood. In this connection it is desirable to improve the wood's ability to resist attacks by fungus, bacteria, insects etc. Durability over the long term is an issue for many wood species if protection against fungal and insect attack is not addressed, typically through chemical impregnation. Chemical preservative treatments will of course enhance the low natural durability of any species.

Consumer and contract law require that any product offered for sale must be fit for its intended use and a wood product impregnated with preservative is no exception.

In this standard, the level of treatment is tailored to the application ‘Use Class’ (UC) of a wood product as defined in European standard EN 335 (Durability of wood and wood-based products).

The Use Classes are defined in the Standard EN 335-1 Definitions of Use Classes as shown below:
UC 1—Internal, dry—for example upper floor joists
UC 2—Internal, risk of wetting—for example tile battens
UC 3.1—Outdoors, coated, above ground—for example window frames
UC 3.2—Outdoors, uncoated, above ground—for example fence rails
UC 4—Direct soil or fresh water contact—for example fence posts
UC 5—Marine use—for example marine pilings

Obviously, there is a desire to improve the wood characteristics, such that wood may be given a higher UC rating and thereby achieve a higher price.

Embodiments of the present invention are especially directed at improving the characteristics of wood such that inferior wood may be given a higher UC (use class)

Esters are derived from carboxylic acids, where the hydrogen in its carboxylic group is replaced by a hydrocarbon group of some kind. This group may be provided from components of the wood cell structure itself such as hemi celluloses or celluloses (“wood esterification”, Hill (2011)), or from an added reactant (“esterification based bulk impregnation”, Hill (2011)) such as sorbitol, glycerol, furfuryl alcohol or DMDHEU.

Dimethylol ethyleneurea (DMDHEU) is an organic compound derived from formaldehyde and urea. It is a colorless solid that is used for treating cellulose-based heavy fabrics to inhibit wrinkle formation. Dimethylol ethylene urea (DMEU) bonds with the hydroxyl groups present in long cellulose chains and prevents the formation of hydrogen bonding between the chains, the primary cause of wrinkling. This treatment produces permanently wrinkle-resistant fabrics and is different from the effects achieved from using fabric softeners.

Esterification is a convenient method for wood surface modification due to the high amount of free hydroxyl groups available in the wood structure. By use of different esterification approaches, improved dimensional stability, improved durability and resistance to fungal degradation, termite resistance, higher fire resistance and improved mechanical durability was obtained. For a review of these approaches, see also Teacä & Tanasa (2020).

The different approaches involve the following general process:

$${RCO}_{2} H + {R}^{′} OH ↔ {RCO}_{2} {HR}^{′} + {H}_{2} O {\to }_{Polymerisation} Polyesters \qquad ( 1 )$$

a) impregnation of the wood with an aqueous solution of a carboxylic acid (including alcohols which can act as a weak organic acid; the solution main involves other agents and catalysts depending on the specific approach)
b) drying of the impregnated wood at lower temperatures to reduce moisture content, and
c) curing of the impregnated wood at elevated temperatures to ensure sufficient esterification.

Hydrolysis of wood (or wood fibers) is a widely used process for breaking down wood into residual components of commercial value, such as biofuel. In the process, the simple sugars are further broken down into Furan and organic acids, mainly acetic acid, as well as other substances.

Thus, for example, the hydrolysis of hemicelluloses in the case of Xyloses/Arabinoses proceeds as follows in (2) below:

$${( {C}_{5} {H}_{10} {O}_{5} )}_{n} {↔}_{{H}_{2} O} {C}_{5} {H}_{10} {O}_{5} {\to }_{{RCO}_{2} H} {RCO}_{2} H + {C}_{4} {H}_{4} O \qquad ( 2 )$$

The main advantage of esterification is that it (in many cases) offers good performance in UC 3, 4 and UC 5 applications, is resistant to termites and offers improved fire retardancy and mass increase properties. The drawback of esterification is that it is a complicated process which causes high product costs, making it less competitive in the market. The reason for this is both high capital and operational expenditures for the industrial process, which is complicated and lengthy.

Thus, if a hydrolysis process could be combined with a simple esterification process, the combined system can produce both lower cost UC 3 purpose products, as well as heavy duty UC 4,5 purpose.

It is well established that the hydrolysis process produces carboxylic (organic) acids as an end product, primarily Acetic acid, in accordance with (2). The formation of such acids can then be utilized in a combined hydrolysis and esterification process.

Embodiments of the present invention are to achieve improved characteristics by utilizing parts of different technologies and take advantage of the chemical properties of the processes.

Embodiments of the invention achieve this by providing a method of treating a cellulose-based material, for example wood and engineered wood, wherein the process involves the following steps:
Selecting and placing the cellulose-based material in a treatment chamber;
Impregnating the cellulose-based material with an impregnating agent consisting of an aqueous solution comprising a fluid suitable for esterification;
Facilitating a hydrolysis process whereby the impregnating agent reacts resulting in the formation of esters and polyesters inside the cellulosed-based material.

Consequently, the idea behind embodiments of the invention is as follows: instead of impregnating the wood with an organic acid according to the first step a) above for esterification, the organic acids produced by the thermal modification process in (2) can substitute this and act as reactant.

All species of wood may benefit from this treatment but particularly spruce, fir, pine, beech, oak, birch and ash, as well as all types of engineered wood such as veneers, glue laminated timber and cross laminated timer, exhibit improved characteristics after having been treated.

Instead, to achieve an efficient and strong esterification of the wood, it suffices to impregnate the wood before hydrolysis and further with a second reactant as mentioned in the general process above under (1), for example sorbitol, glycerol, xylitol, Furfurylalchol or DMEHEU. The combination of esterification process (1) and hydrolysis process (2) then yields the following general process:

$${( {C}_{5} {H}_{10} {O}_{5} )}_{n} {↔}_{{H}_{2} O} {C}_{5} {H}_{10} {O}_{5} {\to }_{{RCO}_{2} H} {RCO}_{2} H + {R}^{′} OH ↔ {RCO}_{2} {HR}^{′} + {H}_{2} O {\to }_{Polymerisation} Polyesters \qquad ( 3 )$$

This new process involves the following steps:
A) Impregnation with aqueous solution of a relevant agent which lends itself well to esterification by providing the needed hydrocarbon group according to (1) above. Examples of relevant agents may be for example sorbitol, glycerol, DMDHEU, Furfurylalcohol or xylitol. Depending on the exact circumstances, the impregnation process can be performed as either a Full Cell or Empty Cell impregnation process. In most cases the process is performed at ambient temperature, although for specific agents elevated temperature of the aqueous solution of 40-70 degrees may be advantageous. For vacuum phase, pressure down to 0.1 Bar(A) may be applied, while for the pressure phase pressure up to 15 Bar(A) may be applied.
C) Hydrolysis of the wood whereby the organic acids produced by the hydrolysis reacts with the reactant impregnated into the wood in step A, resulting in the formation of esters and polyesters. Depending on the particular monomer and the particular product, Pressure is elevated to 5-20 Bar(A) and temperature to 100-175° C., which are kept during a holding phase lasting between 30 minutes and 12 hours, before cooling down again to ambient temperature.

The holding phase is important at this stage Due to potential uneven temperature distribution, the holding phase will ensure an even temperature across the cellulose-based material being treated. Furthermore, as the hydrolysis and polymerization occur during this period, it is important to maintain the holding phase for long enough time, to assure that the desired level of polymerization and hydrolysis has had enough reaction time In this manner it is assured that a homogeneous result is achieved. Once the desired level of polymerization and hydrolysis has been achieved the temperature and pressure may be reduced to ambient conditions. The desired level will typically be 100% or as close to 100% as possible.

The main advantage is that softwood can be used for applications that require high durability, which might be seen as environmentally friendly. Durability class 1-3, according to European Standard EN 350-2, can be obtained out of non-durable (class 5) softwood species.

The biological resistance against some (not all) micro-organisms and insects is improved. Shrinking and swelling is reduced up to 50-90% The treated wood is somewhat darkened in color.

As a principle the treatment process can be done on all wood species.

As an optional step it may in some embodiments, particularly depending on the type of wood being treated be advantageous to dry the impregnated wood down to a level which allows for thermal modification. In this context this means drying, such that the water content in the impregnated cellulose-based material is between from 0 wt % to 20 wt % water. Typically, this drying step will be performed prior to hydrolysis.

### AN EXAMPLE OF A COMBINED HYDROLYSIS AND FURFURYLAZATION PROCESS

This process can be done in different ways. In particular, it can be done in either a one step or a two-step process.

In the one step process, furfurylalcohol (FA) is vaporized within the chamber used for the hydrolysis process, so that the vaporized FA penetrates the wood cells simultaneously with the hydrolysis process.

In the two-step process, wood is first impregnated with an aqueous solution of FA in the first step. In the second step, the impregnated wood is hydrolyzed, and FA is polymerized simultaneously.

One step process.

First, the selected wood is arranged inside the chamber suitable for hydrolysis. The chamber can be heated, cooled and pressurized. In the bottom of the chamber, an aqueous solution of FA is placed in an open container, which can be heated to a point where FA evaporates.

Second, a vacuum of 0.2 Bar(A) for 30 min. is established, in order to empty the cells for atmospheric air and make room for FA vapor.

Third, the chamber is pressurized to 15 Bar(A)

Fourth, the chamber is heated to 150 deg. C. During the heating, the FA is heated until it evaporates, and is then circulated around the wood inside the chamber. Due to the high pressure, the FA vapors penetrate the empty wood cells.

Steps three and four can be combined in one step where pressure and heat are increased simultaneously. The preceding steps constitutes the impregnation process.

When the wood temperature reaches the desired temperature of 150 deg. C., the pressure and temperature is kept stable for two hours in a holding phase. During this phase, wood hemicelluloses is hydrolyzed into carboxylic acids and other residuals. Simultaneously, the vaporized FA inside the wood cells react with the carboxylic acids produced by the hydrolysis, resulting in the polymerization of the FA into a furan polymer.

The combined hydrolysis of hemicelluloses and furan polymer in the wood cells, results in increased durability against rot and fungi, increased dimensional stability and a number of other positive effects on the wood.

Fifth, the chamber is cooled down to ambient temperature, and

Sixth, the pressure on the chamber is brought down to atmospheric pressure, after which the chamber can be opened, and the modified wood taken out.

### Two-Step Process

### First Step—Impregnation

First, the selected wood is placed in a chamber suitable for vacuum and pressure impregnation with aqueous solutions, and the door is closed and sealed.

The impregnation process can be in two different ways:

Example with full cells, meaning that a lower initial pressure is present, such that as the method progresses air is injected into the cells before the impregnating fluid is introduced and forced not the wood. When the pressure is lowered again (till normal atmospheric pressure) the trapped air will create a kick-back, forcing some of the fluid out again. In this manner impregnating fluid may be saved, without compromising the impregnation.

First, pressure in the chamber is elevated to 5 bar(A).

Second, the chamber is filled with the FA solution.

Third, pressure in the chamber is elevated to 15 bar(A).

Fourth, the pressure is kept for 2 hours, or until full uptake of the FA fluid is achieved.

Fifth, the chamber is emptied for FA fluid.

Sixth, a vacuum of 0.2 Bar(A) is established and maintained for 1 hour.

Example with empty cells, meaning that a pre-vacuum is established in order to extract any air from the cells of the wood. This is followed by forcing the impregnation fluid into the now empty cells.

First, a vacuum of 0.2 Bar(A) is established in the chamber.

Second, the chamber is filled with the FA solution.

Third, the pressure in the chamber is elevated to 15 Bar(A).

Fourth, the pressure is kept for 2 hours, or until full uptake of the FA fluid is achieved.

Fifth, the chamber is emptied for FA fluid.

Sixth, a vacuum of 0.2 Bar(A) is pulled and maintained for 1 hour.

### Second Step—Hydrolysis and Polymerization

First, the selected wood is put inside the chamber suitable for hydrolysis. The chamber can be heated, cooled and pressurized. The door is closed and sealed.

Second, the pressure in the chamber is elevated to 15 Bar(A).

Third, the temperature is elevated to 150 deg. C.

Steps two and three can be combined in one step.

Fourth, when the wood temperature reaches the desired temperature of 150 deg. C., the pressure and temperature is kept stable for two hours in a holding phase. During this phase, wood hemicelluloses is hydrolyzed into carboxylic acids and other residuals. Simultaneously, the aqueous solution of FA inside the wood cells reacts with the carboxylic acids produced by the hydrolysis, resulting in the polymerization of the FA into a furan polymer.

The combined hydrolysis of hemicelluloses and furan polymer in the wood cells, results in increased durability against rot and fungi, increased dimensional stability and a number of other positive effects on the wood.

Fifth, the temperature in the chamber is brought down to ambient temperature, and

Sixth, the pressure in the chamber is brought down to atmospheric pressure, after which the door can be opened, and the wood taken out.

The process/method according to embodiments of the invention are technically less complicated and commercially less costly for producing esterification-based type of products for heavy duty applications, compared to the traditional approaches mentioned above.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1-8. (canceled)

9. A method of treating a cellulose-based material, for example wood and engineered wood, wherein the process involves the following:
a) selecting and placing the cellulose based material in an impregnation chamber;
b) impregnating the cellulose based material with a solution containing a monomer(s) to be esterified;
c) placing the impregnated cellulose-based materials in a modification chamber;
d) elevating the pressure in the modification chamber to above normal atmospheric pressure;
e) heating the pressurized impregnated cellulose-based material to above ambient temperature until polymerization has been completed; and
f) lowering the temperature to ambient temperature and lowering the pressure in the chamber to atmospheric pressure.

10. The method according to claim 9, wherein the cellulose-based material is wood or engineered wood, and spruce, fir, pine, beech, oak, birch, ash.

11. The method according to claim 9, wherein the fluid suitable for esterification is selected from the hydrocarbon group, where members are sorbitol, glycerol, Furfurylalcohol or xylitol.

12. The method according to claim 9, wherein the fluid suitable for esterification is DMDHEU.

13. The method according to claim 9, wherein the general chemical process for the esterification in the cellulose-based material is:

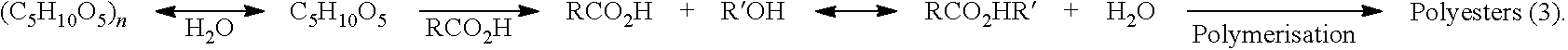

14. The method according to claim 9, wherein for certain monomers and cellulose-based materials pressure is elevated to 5-20 Bar(A) and temperature to 100-175° C. in the modification chamber, which temperature and pressure is maintained during a holding phase lasting between 30 minutes and 12 hours, before cooling down again to ambient temperature and pressure release to ambient pressure.

15. The method according to claim 9, wherein the impregnating chamber and modification chamber is the same chamber and where step b) involves first establishing a vacuum for a predetermined period, followed by an increase in pressure.

16. A wood treated according to a method according to claim 9.
